(19) United States
(12) Patent Application Publication
(10) Pub. No.: US 2001/0007342 A1
(43) Pub. Date: Jul. 12, 2001

(54) Pipe and equipment support systems

(76) Inventor: Ronald G. McCracken, Magnolia, TX (US)

Correspondence Address: Shawn Hunter, BRACEWELL & PATTERSON, L.L.P., 711 Louisiana, Suite, 2900, Houston, TX, 77002, US

(21) Appl. No.: 09/772,145

(22) Filed: Jan. 29, 2001

Related U.S. Application Data
(63) Continuation-in-part of application No. 09/388,695, filed on Sep. 2, 1999.
(63) Continuation-in-part of application No. 09/388,522, filed on Sep. 2, 1999, now Pat. No. 6,229,497.

(51) Int. Cl. F16L 3/00; F16L 3/22

(52) U.S. Cl. 248/68.1; 248/49

(57) ABSTRACT

Systems and methods for the support of rooftop piping. A plurality of pipe stands are used to support sections of piping. The pipe stands provide a balanced stand-alone support structure that is unaffixed to the rooftop during use. The stands are balanced in that the frame is supported by multiple bases, and the frame is configured so that movement of the frame with respect to the bases is limited in all directions. Further, weight-distributing bases are provided that prevent the weight loads transmitted through the frame from becoming point loads. In other aspects, a support stand is used for supporting related equipment such as telephone junction boxes. This support stand, like the support stands for the piping, provides a stable support platform for the equipment with more than two points of contact.

This application is a continuation-in-part of U.S. patent application Ser. No. 09/388,695 and U.S. patent application Ser. No. 09/388,522, both filed Sep. 2, 1999.

### BACKGROUND OF THE INVENTION

1. Field of the Invention

The invention relates to devices and methods for supporting pipes and other equipment on rooftops and other support surfaces.

2. Description of the Related Art

The rooftops of commercial buildings are typically used to support heating and air conditioning units, as well as other equipment. Thus, it is common to have piping or conduit, which supports these units, extending across the rooftop. This piping must be supported above the surface of the rooftop. Support helps prevent the piping from being damaged by contact with the rooftop surface or by mechanical stresses upon the piping segments induced by changes in temperature. Wooden blocks, cut-to-size, are often used to provide support for the piping. However, their use has a number of well-recognized problems, including the fact that the wooden blocks tend to move upon the surface of the roof over time. The wooden blocks typically have sharp comers and hard edges that can easily puncture the membrane of the roof, resulting in leakage or even structural damage.

There are a number of conventional prefabricated assemblies known for supporting these types of piping systems. Unfortunately, these have disadvantages that reduce their effectiveness in actual use. For example, U.S. Pat. No. 5,906,341 issued to Brown describes a pipe supporting system wherein saddles that receive the pipes are supported by upright members that are cut-to-length. Bases are affixed to the lower ends of the upright members to contact the rooftop. Unfortunately, in Brown's system the bases are typically secured to the rooftop using screws which penetrate the rooftop, thereby damaging it. In addition, such systems are prone to balance problems since they lack support in the front and rear of the support that would cause it to tip as pipe is urged through the saddle. Further, the saddle assemblies used with this type of system are relatively complex and expensive as they incorporate a roller ball bearing system for support of the pipes.

U.S. Pat. No. 4,502,653 issued to Curtis, Jr. describes use of support blocks that rest upon the rooftop and support underside portions of the pipes. Such systems are problematic. If screws are used to secure the blocks to the rooftop, leakage and damage problems may result. If the support blocks are not secured to the rooftop, they are prone to movement as a result of temperature change or mechanical trauma. This movement may ultimately cause support for the pipes to fail.

U.S. Pat. No. 5,829,718 issued to Smith describes use of pipe supports that have rectangular bases that support a frame thereon. The frame carries one or more yokes within which one or more pipes are disposed for support. An adhesive is used to secure the bases to the rooftop. In practice, these pipe supports have proven problematic. Adhesives use to affix the base to the rooftop tend to break down over time. The base itself, has relatively sharp comers that may penetrate the rooftop membrane. Thus, the bases may cause rooftop damage after long periods of use.

A particular area of weakness for the type of pipe supports discussed in Smith is the point at which the frame is secured to the base. A U-shaped frame is affixed to the rectangular base and transmits the weight of the pipe to the base. However, there are only two points of contact between the frame and the base, and the frame can often be easily lifted out of the base. As a result, the arrangement can be somewhat less than sturdy, and the frames are prone to tipping, particularly when the pipes are urged through the frame since the pipes are being slid perpendicular to the strong axis of support.

Devices and methods that overcome the problems of the prior art would be desirable.

### SUMMARY OF THE INVENTION

Systems and methods are described for providing adequate and lasting support for rooftop piping without the potential for damage to the rooftop. A plurality of pipe stands are used to support sections of piping. The pipe stands provide a balanced stand-alone support structure that is unaffixed to the rooftop during use. The stands are balanced in that the frame is supported by multiple bases, and the frame is configured so that movement of the frame with respect to the bases is limited in all directions. Further, weight-distributing bases are provided that prevent the weight loads transmitted through the frame from becoming point loads.

In other aspects, the invention teaches a support stand for supporting related equipment such as telephone junction boxes. This support stand, like the support stands for the piping, provides a stable support platform for the equipment with more than two points of contact.

### BRIEF DESCRIPTION OF THE DRAWINGS

FIG. 1 is a front view of an exemplary pipe stand constructed in accordance with the present invention.

FIG. 2 is a side view of the pipe stand shown in FIG. 1.

FIG. 3 is an isometric view of the pipe stand shown in FIGS. 1 and 2.

FIG. 4 illustrates the use of multiple pipe stands to support a pair of pipes above a rooftop surface.

FIG. 5 is a front view of an alternative design for an exemplary pipe stand constructed in accordance with the present invention.

FIG. 6 is an isometric view of a design for an exemplary equipment stand constructed in accordance with the present invention.

### DETAILED DESCRIPTION OF THE PREFERRED EMBODIMENTS

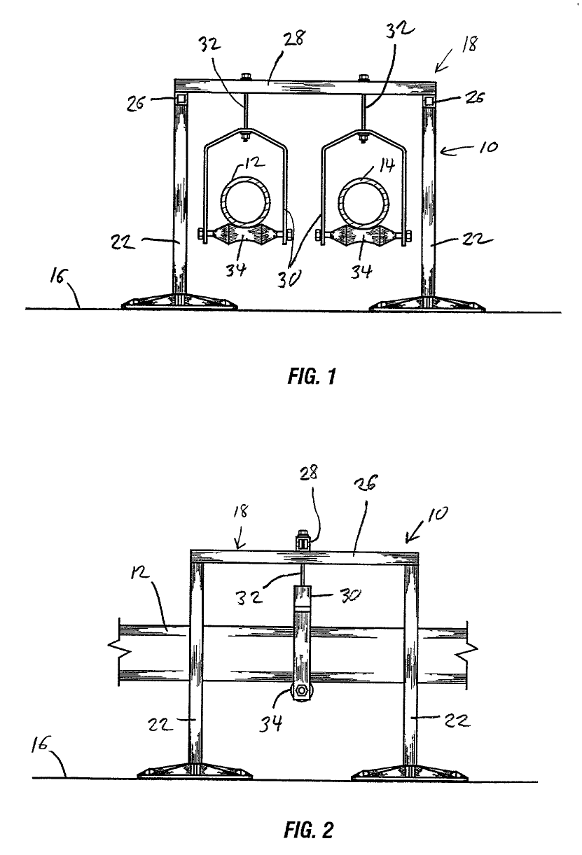

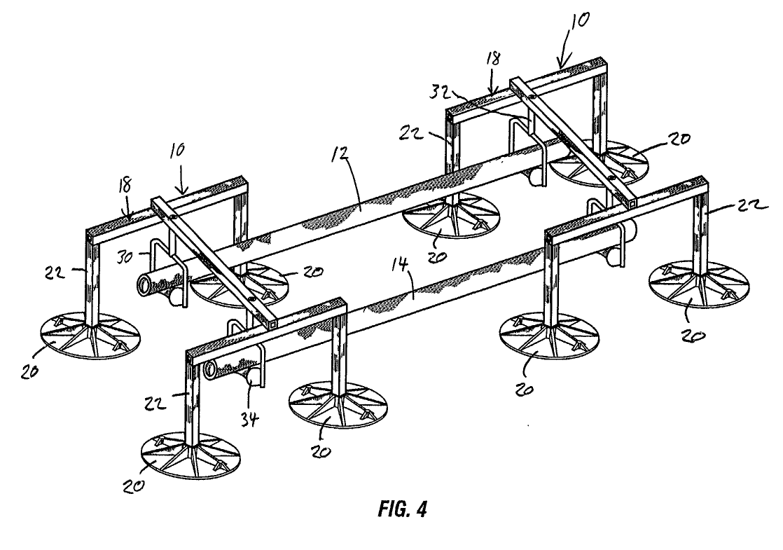

FIGS. 1-4 illustrate a first embodiment of the invention wherein a system of pipe stands 10 are used to support parallel sections 12, 14 of piping above the support surface 16 provided by a rooftop or similar support surface. FIGS. 1-3 illustrate a single exemplary pipe stand 10. FIG. 4 shows multiple pipe stands 10 being used to support lengths of the piping sections 12, 14.

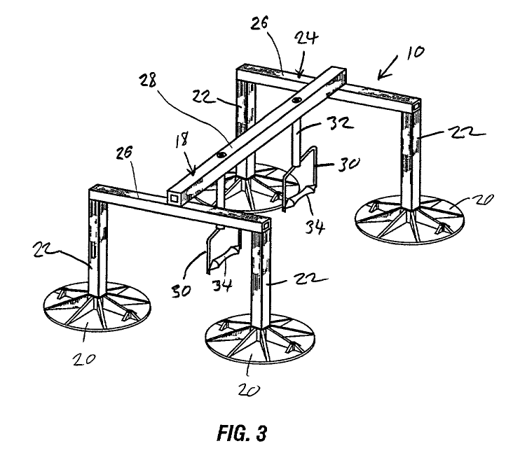

Each pipe stand 10 is formed primarily of iron, steel or another suitable rigid and sturdy substance. The pipe stand 10 includes a frame 18 and four load-distributing support bases 20. The frame 18 has four substantially vertically disposed legs 22 and an H-shaped upper support portion 24 that is best seen in FIGS. 3 and 4. The H-shaped upper portion 24 is made up of two horizontally disposed braces 26 and a cross-member 28 that interconnects the two braces. The braces 26, cross-member 28 and legs 22 are rigidly secured to one another so as to provide a stable frame 18. These components may be rigidly secured to one another by welding, the use of nut-and-bolt type connectors or in other ways known in the art.

As noted, the bases 20 are load-distributing bases, preferably of the type described in U.S. Pat. No. 5,816,554 issued to the inventor of the present invention and entitled “Equipment Support Base.” That patent is incorporated herein by reference. These bases distribute the weight load of the frame 18 and piping 12, 14 across the surface 16 of the roof so that point loading is avoided. In addition, no penetrating connectors are needed to affix the bases 20 to the rooftop 16. Therefore, leakage and other damage to the rooftop membrane is avoided.

It is noted that the pipe stand 10 has four points of contact with the support surface 16. The four legged design of the frame 18 also provides sturdy support along both the longitudinal axis of the piping 12 and 14 as well as the axis perpendicular to the piping.

In the embodiment depicted in FIGS. 1-4, the piping 12, 14 is supported by yokes 30 that are suspended from the cross-member 28 by a threaded rod 32. A roller 34 is located on the bottom of each yoke 30 to aid in disposing the piping 12, 14 through the yokes 30.

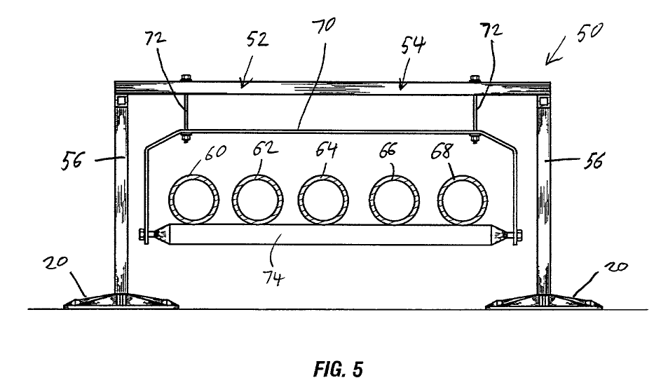

FIG. 5 illustrates an alternative embodiment for a support stand 50 that is constructed in accordance with the present invention. The support stand 50 includes a frame 52 that has an H-shaped upper support portion 54 and four vertically-disposed support legs 56 (two visible) in the same manner as the support stand 10 described previously. The support stand 50 also includes support bases 20 affixed to the lower ends of the legs 56. The support stand 50 is designed to support several parallel piping segments 60, 62, 64, 66 and 68 within a single yoke 70. The yoke 70 is suspended from the frame 52 by two threaded rods 72 and has an elongated lower roller 74.

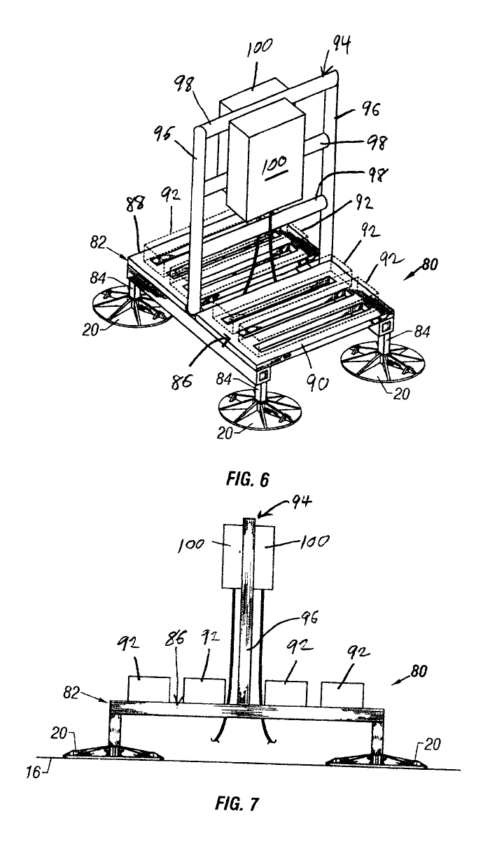

FIGS. 6 and 7 depict an equipment support platform 80 that includes a frame 82 and a plurality of load-distributing support bases 20. The frame 82 includes four vertically disposed legs 84 and an upper support portion 86 from which each of the four legs downwardly depend. As FIG. 6 illustrates, the upper support portion 86 consists of a pair of grates 88, 90 that permit airflow and drainage there through. In practice, the upper support portion 86 is used to support weighted loads, such as the weights 92 illustrated in FIGS. 6 and 7.

A substantially vertically disposed frame portion 94 extends upwardly from the support portion 86. The frame portion 94 has a pair of side supports 96 and three cross-pieces 98. Telecommunications boxes 100 are secured to the frame portion 94.

Although the invention has been described in terms of its preferred embodiments, it will be apparent to those of skill in the art that it is not so limited. Various modifications, changes and alterations may be made to the preferred embodiments without departing from the scope and spirit of the claims.

What is claimed is:

1. A frame assembly for supporting a pipe segment or the like comprising:
an upper support portion;
a supporting platform suspended from the upper support portion; and
four or more substantially vertically disposed leg members that depend from the upper support portion.

2. The frame assembly of claim 1 further comprising a load distributing base affixed to each of the leg members.

3. The frame assembly of claim 1 wherein the upper support portion is substantially H-shaped.

4. The frame assembly of claim 1 wherein the supporting platform comprises a yoke.

5. The frame assembly of claim 4 wherein the supporting platform further comprises a roller.

6. The frame assembly of claim 1 wherein the upper support portion comprises a grate that permits airflow and drainage therethrough.

7. The frame assembly of claim 6 wherein the upper support portion supports weights for stabilization of the frame assembly.

8. A frame assembly for supporting a pipe segment or the like comprising:
an upper support portion;
four or more substantially vertically disposed leg members that depend from the upper suspension portion; and
a load distributing base affixed to each of the leg members.

9. The frame assembly of claim 8 wherein the upper support portion comprises a substantially H-shaped frame portion having a yoke suspended therefrom for supporting a section of pipe.

10. The frame assembly of claim 8 wherein the load distributing bases are circular in shape.

11. The frame assembly of claim 8 wherein the upper support portion comprises a platform for placement of weights to stabilize the frame assembly.

12. The frame assembly of claim 11 wherein the platform further comprises an apertured grate that permits airflow and drainage therethrough.
